(19) United States
(12) Patent Application Publication
(10) Pub. No.: US 2026/0336743 A1
(43) Pub. Date: Oct. 29, 2026

(54) HANDLEBAR DEVICE FOR A MOTORCYCLE OR BICYCLE

(71) Applicant: Joan Miquel JAUME JUNCÀ, Girona (ES)

(72) Inventor: CÉDRIC CHOFFAT, Girona (ES)

(73) Assignee: Joan Miquel JAUME JUNCÀ, Girona (ES)

(21) Appl. No.: 19/107,161

(22) PCT Filed: Aug. 28, 2023
(86) PCT No.: PCT/IB2023/058475

§ 371 Date: Feb. 27, 2025

(30) Foreign Application Priority Data
Aug. 29, 2022 (EP) 22382803.9

(51) Int. Cl. B62K 21/16; B62J 23/00; B62J 29/00; B62K 11/14; B62K 21/18

(52) U.S. Cl. CPC B62K 21/16; B62K 11/14; B62J 23/00; B62J 29/00; B62K 21/18

(57) ABSTRACT

A structural connecting device for a multi-part handlebar assembly of an off-road motorcycle/bicycle, in particular for connecting a central bar of the handlebar configured to be connected to the motorcycle/bicycle by one or more clamping elements, with a lateral bar of the multi-part handlebar assembly, where the structural connecting device is configured as a monobloc part including: a first and a second receiving portions, each including a tubular section having a tubular inner wall extending longitudinally from a receiving opening, through the receiving portion, up until a final end of the tubular section; and an intermediate connecting portion configured to connect the first and second receiving portions.

### FIELD OF THE INVENTION

The present invention is in the field of handlebars for motorcycles and bicycles suitable for both on-road and, specially, for off-road use. In particular, refers to a structural connecting device for connecting several tubular parts of multi-part handlebar assembly, to a multi-part handlebar assembly, and to a kit comprising at least two pairs of structural connecting devices, each pair configured to provide a different ergonomic configuration.

### BACKGROUND OF THE INVENTION

Motorbike and bicycle handlebars suitable for both on-road and off-road applications are generally designed and sized to withstand the severe stresses of off-road use (e.g., intensive vibrations caused by an irregular off-road path, or landing with the motorcycle or bicycle after a jump).

A first typical solution for this type of handlebars comprises a main tubular bar, conveniently curved with a central area having a lower height than the two end portions for ergonomic purposes, and a reinforcement bar connected to the main tubular bar at two respective symmetrically arranged connection points.

A second know solution comprises a main tubular bar, conveniently curved according to the first typical solution, wherein the main tubular bar is configured to have a variable diameter, such that the main tubular bar has a larger diameter in the central area having a lower height, whereas the two respective end portions have a smaller diameter. This solution may be used in combination with a reinforcement bar as described for the first typical solution.

The first and second solutions are based on the use of main tubular bars having a curved configuration. These solutions have the disadvantage that the choice of the material of the main tubular bar is restricted to those materials that allow the manufacture of a curved tube, thus ruling out some materials that have higher strengths just because they cannot be properly bent during the manufacturing process. Additionally, when a reinforcement bar is used, this has the disadvantage that some efforts are specifically concentrated around the connecting points, therefore increasing the risk of having a breaking point around the connection points. Another disadvantage of the prior art solutions is that the handlebars can only be removed entirely from the vehicle, as a single-body part, which is not practical for transport purposes due to the presence of clutch and/or braking cables on the handlebar. Further, these solutions do not provide any kind of energy absorption in order to reduce the vibrations that the rider receives through the handlebar, or to dissipate some of the energy resulting from a landing after a jump.

Therefore, there is room for technical improvement regarding handlebars for motorcycles and bicycles suitable for both on-road and off-road use.

### SUMMARY OF THE INVENTION

The present invention addresses the problem of providing a handlebar for motorcycles/bicycles for on-road and/or off-road use with an improved usability and having an improved resistance. In particular, the handlebar according to the invention is partially dismountable/detachable for reducing the space taken by the motorcycle during transportation operation. This problem is solved by a device according to claim 1 and a multi-part handlebar according to claim 10. Preferred embodiments of the invention are defined in the appended dependent claims.

A first aspect of the invention refers to a structural connecting device for a multi-part handlebar assembly of an off-road motorcycle/bicycle. In particular, the structural connecting device is suitable for connecting a central bar of the handlebar (i.e. of the multi-part handlebar assembly) with a lateral bar of the handlebar, wherein the multipart handlebar generally comprises a single central bar and at least two lateral bars. The central bar is configured to be connected to the motorcycle/bicycle (i.e. to the fork of the motorcycle/bicycle) by means of one or more clamping means (e.g., a set of handlebar raisers or on or more handlebar stems) to enable steering of the motorcycle/bicycle. The lateral bars may comprise a hand grip portions for receiving the hands of the rider. The structural connecting device is a monobloc part (i.e., it is a monolithic device formed as a single body part). The structural connecting device may be made of metal, preferably selected from aluminium, steel or titanium, and more preferably being made of aluminium A17075 T6, which provides a suitable balance between the mass (and therefore the inertia generated by the device) and the mechanical resistance.

The structural connecting device comprises respective first and second receiving portions and an intermediate connecting portion configured to connect the first and second receiving portions. In some embodiments, the monobloc/monolithic structural connecting device may be configured such that the first and the second receiving portions are individually shaped/formed, such that the first and second receiving portions have a particular shape/form (e.g. one or each of the receiving portions may be configured to be substantially shaped/formed as a respective tubular or pseudo-tubular part), thereby the first and second receiving portions being visually identifiable when observing the monolithic structural connecting device. This configuration is particularly suitable for optimizing the mass of the structural connecting device. In other embodiments, the structural connecting device may be shaped/formed such that the first and second receiving portions are not externally identifiable by its shaped/form.

Each of the first and second receiving portions comprises a respective tubular section comprising a tubular inner wall extending longitudinally (i.e., along the longitudinal direction of the respective tubular section) from a receiving opening, through the receiving portion, up until a final end of the respective tubular section. Thus, for each of the first and second receiving portions, the respective receiving opening and the respective final end are configured as the two respective longitudinal distal end portions of the respective receiving portion. The tubular section of the first receiving portion is configured to receive (e.g. by insertion) a bar end of a central bar of the multi-part handlebar assembly, wherein the tubular section of the second receiving portion is configured to receive (e.g. by insertion) to a bar end of a lateral bar. The receiving opening of the first receiving portions may be configured to receive (e.g. by insertion, i.e. by inserting the bar end into the respective tubular section through the receiving opening) a bar end of the central bar, while the receiving opening of the second receiving portion is configured to receive (e.g. by inserting the bar end into the respective tubular section through the receiving opening) a bar end of one of the lateral bars, such that said bar end is insertable into the tubular section. Each tubular section may be further configured to be attached to the respective bar end, e.g. by providing the respective tubular section with through-pass holes arranged to coincide with respective through-pass holes of the bar ends, such that one or more mechanical attaching element (e.g. rods or screws) may be used to attached together the respective bar end to the respective tubular section.

The intermediate connecting portion is configured to connect the first and second receiving portions, such that the receiving openings of the first and second receiving portions are arranged as respective longitudinal ends (i.e. opposed ends along a longitudinal direction of the structural connecting device defining a maximum length of the device along said longitudinal direction) of the structural connecting device, and such that at least one of the respective final ends is arranged between the two receiving openings in the longitudinal direction of the structural connecting device. In preferred embodiments, the two respective final ends (i.e., of the first and second receiving portions) are arranged between the receiving openings in the longitudinal direction of the structural connecting device. The longitudinal direction may be configured to extend at least mainly along the first direction.

The tubular section of the first receiving portion is configured to have a first length extending longitudinally along (e.g. along and around) a first central geometrical axis extending along a first direction (in a preferred position of use of the structural connecting device, the first direction may be configured as a substantially horizontal direction, wherein the first central geometrical axis is separated from the respective inner wall by a first distance in a radial direction of said axis (i.e. the first distance may be regarded as a first radial distance). A radial direction is construed in the context of the present application as a direction extending from and perpendicular to a respective central geometrical axis. In the context of the invention, a geometrical axis is regarded as an external spatial reference not being part of the invention. The first distance may have a length in the range 11 mm to 17.5 mm, preferably 13 mm to 15 mm, and more preferably measures 14.3 mm. The first length may be configured to measure 2 to 5 times the first distance, preferably 3.5 times.

The tubular section of the second receiving portion is configured to have a second length extending longitudinally along (e.g. along and around) a second central geometrical axis extending partially along the first direction, and to a lesser extent, also partially in a second direction, the second direction being perpendicular to the first direction (in a preferred position of use of the structural connecting device, the second direction may be configured as a substantially vertical direction), thereby defining a first angle between the first geometrical axis and a projection of the second central geometrical axis on a first geometrical plane formed by the first central geometrical axis and the second direction (i.e. the first geometrical plane is configure to comprise/contain the first central geometrical axis and the second direction), and wherein the second central geometrical axis is separated from the respective inner wall by a second distance in a radial direction of said axis. The first angle is smaller than 45 degrees, and may be in the range 0.5 to 30 degrees, preferably 3 to 8 degrees, and more preferably 4 to 6 degrees (being 4.66 degrees a preferred value). The second distance may have a length in the range 11 mm to 17.5 mm, preferably 13 mm to 15 mm, and more preferably measures 14.3 mm. The first length may be configured to measure 2 to 5 times the first distance, preferably 3.5 times.

It should be noted that a predetermined tolerance of between 5% and 10% is applicable to all measurements (i.e. ranges, lengths, angles, multiples of length, diameters, hardness values in shores, etc) and numerical data provided along the description and the claims.

Preferably, the tubular sections of the first and/or of the second receiving portions may be configured to have a circular cross-section, e.g. by being configured as tapered tubular sections (i.e. with a circular cross-section having a plurality of diameters along a length of the tubular section) or as cylindrical tubular straight sections (i.e. with a circular cross-section having a uniform diameters) (such that the first and second distances correspond to the radius of the respective tubular straight section). When the tubular sections are not configured as straight tubular sections, e.g. when they are configured as tapered tubular sections (i.e. having a variable distance with respect to its respective central geometrical axis), then the first and second distances are interpreted as corresponding to the minimum (or the average) radial distances between the respective central geometrical axis and the respective inner wall (when considering the whole length of the respective tubular section).

In some embodiments, the tubular section of the first and/or of the second receiving portions has a cross-section (i.e., a cross-section on a plane perpendicular to its respective central geometrical axis) in the form of a regular polygon, preferably having 4 to 16 sides. In preferred embodiments, said cross-sections are constant along the respective central geometrical axis of the respective tubular section. All the cross-sections shapes (and any combination thereof) described for the tubular sections are broadly compatible with all the embodiments described in the claims.

The inner wall of the second receiving portion is positioned separated from the first central geometrical axis in the second direction, such that a point of the inner wall of the second receiving portion being arranged closest to the first central geometrical axis is spaced apart from said axis by a third distance (i.e. the third distance being configured as a radial distance) in the second direction. Thus, the tubular section of the second receiving portion is arranged at a higher position in the second direction (when the structural connecting device is arranged in a preferred position of use in which the second direction is a vertical direction) than the tubular section of the first receiving portion. The third distance is in the range 50-250%, preferably 100-200%, and more preferably 140-160% of the first distance.

It is noted that the optional spatial references relating to the correspondence of the first and second directions to the horizontal and vertical directions respectively, are provided considering an initial/standard position of the structural connecting device, which corresponds to the position in which such a device is normally arranged when mounted on a multi-part handlebar assembly. However, and obviously, this device can be rotated by a user when mounted on a multi-part handlebar assembly to be arranged in a different position, so that the correspondence of horizontal and vertical directions may be altered in the multi-part handlebar assembly, but the relative positions shall remain the same.

The second central geometrical axis may be further configured to extend partially along a third direction, the third direction being perpendicular to both the first and second directions, thereby defining a second angle between the first central geometrical axis and a projection of the second central geometrical axis on a second geometrical plane formed by the first central geometrical axis and the third direction. In some embodiments. The second angle is smaller than 45 degrees, and may be in the range 5 to 30 degrees, preferably 10 to 18 degrees, and more preferably 12 to 15 degrees (being 13 degrees a preferred value).

I tubular section of the first and/or of the second receiving portions may be configured to receive at least one mechanical attaching element configured to fix/attach the respective bar end of the central bar or the lateral bar to the respective tubular section. Preferably said at least one mechanical attaching element may be configured as at least one bolt/screw/axis arranged transversely to the respective tubular section, passing through its respective inner wall (once or twice), and/or as at least one bolt/screw arranged along the longitudinal direction of extension of the respective tubular section (i.e. a direction coincident with the respective central geometrical axis of the respective tubular section), passing through the respective final end of the respective tubular section. In preferred embodiments, the second receiving section (i.e., the one configured for receiving an end of a lateral bar) may comprise one or more mechanical attaching element, while the first receiving section (i.e., the one configured for receiving an end of the central bar) may comprise two or more mechanical attaching elements. At least one of the one or more mechanical attaching element (e.g. mechanical connector) may be configured to be connected to a respective nut. Preferably, the structural connecting device may be configured to receive by form-fitting the nuts of the mechanical attaching elements, such that the nuts are prevented from moving relative to the structural connecting device. A connection by form-fitting refers to a type of mechanical connection between two components or parts where the fit between them is designed to be precise and interlocking. In this type of connection, the parts fit together in a way that minimizes any play or movement between them, ensuring stability, alignment, and efficient transfer of forces between the components. Thus, the structural connection device may comprise one or more housing areas, each housing area having the shape of a nut to receive and form-fit with one of the nuts.

The tubular section of the second receiving portion may be configured to receive a damping element, preferably a sleeve/bushing element (e.g., having circular cross-section, such as a hollow cylinder or tubular element), configured as a separator/spacer (i.e. a contact interface) between the respective end of the lateral bar and the inner wall of the tubular section of the second receiving portion. The damping element may be configured to have a thickness in the range 1 to 6 mm, preferably 2 to 5 mm, and more preferably 3 to 4 mm. The damping element may be made of plastic material having elastic properties, preferably a polymer, such as nylon or polyurethane (e.g. polyurethane resin) or polyethylene (PE), especially a high-density polyethylene HD-PE). In preferred embodiments, the damping element may me made of polyurethane resin or made of a PE in the range PE-200 to PE-600, preferably in the range PE-400 to PE-500. Thus, the one or more mechanical attaching elements of the tubular section of the second receiving portion may be configured to fix/attach the respective bar end of a lateral bar to both the damping element and the respective tubular section.

The damping element may be configured to be attached to the respective tubular section such that the damping element is prevented from moving relative to said tubular section. Preferably, the damping element may be configured to be attached to the respective tubular section by means of a mechanical attaching element configured to fix/attach the respective bar end of a lateral bar to the respective tubular section of the second receiving portion.

The damping element may be configured to have a hardness measured in shores in the range 75 A to 98 A shores, preferably in the range 80 A to 96 A shores and more preferably in the range 90 A to 95 A shores. It should be noted that a “shore” is a unit of measurement used to describe the hardness of materials, specifically polymers and elastomers. It measures the resistance of a material's surface to indentation or penetration by a harder object. The Shore hardness scale is commonl′ used in industries such as rubber, plastics, and various soft materials. There are different scales within the Shore hardness system, denoted as Shore A, Shore B, Shore C, etc. Each scale uses an (standardised) different type of indenter and applied force, leading to slightly different measurements. In the present invention, the measures of shores are provided refer to the scale Shore A.

In a preferred embodiment, the damping element is configured to have a circular cross-section (e.g. as a hollow cylinder or as a tubular element) made of polyurethane resin having a hardness in the range 90 A to 98 A shores (95 A shores being a preferred value) shores and a thickness in the range 3 to 4 mm.

IThe final end of the tubular section of the first and/or of the second receiving bodies is configured as (or comprises) a final end surface configured to close the tubular section (i.e., the final end surface is a closure), such that the respective tubular section has a closed end (i.e., is a blind tubular section). Preferably the final end surface is configured as a planar surface being perpendicularly arranged to the respective central geometrical axis of the respective tubular section. In some embodiments, the final end of the tubular section of the first and/or the second receiving body may be configured as a final end opening, such that the respective tubular section has two open ends (i.e., the receiving opening and the final end opening) being longitudinally opposed.

In preferred embodiments, the intermediate connecting portion may comprise a first reinforcing element (e.g., a wall) configured to connect at least a longitudinal portion of the tubular section (wherein the first reinforcing element may be configure to extend along the whole length of the tubular section) of the second receiving portion extending from its respective final end towards its respective receiving opening, with at least a part of the final end of the tubular section of the first receiving portion. Preferably, said longitudinal portion of the tubular section of the second receiving portion corresponds to a lower portion/part (when considering a preferred position of use of the structural connecting device) of the tubular section with respect to the second direction. It is noted that, as previously described, the final end of the tubular section of the first and/or the second receiving portion may be configured either as a final end surface (configured as a final end closing of the respective tubular section), or as a final end opening. When the final end of the tubular section of the first receiving portion is configured as final end surface, then the above-referred at least a part of the final end of the first receiving portion may be a at least a part of the final end surface. When the final end of the tubular section of the first receiving portion is configured as final end opening, then the above-referred at least a part of the final end of the first receiving portion may be a at least a part of the permitter of the final end opening. Preferably, said longitudinal portion of the tubular section of the second receiving portion extends from its respective final end towards its respective receiving opening by at least a 40-60%, more preferably by at least 80-100%, of the second length.

In some embodiments, and regardless of whether the intermediate connecting portion comprises a first reinforcing element (e.g. a wall) or not, the intermediate connecting portion may comprise a second reinforcing wall configured to connect at least a longitudinal portion of the tubular section (wherein the first reinforcing element may be configure to extend along the whole length of the tubular section) of the first receiving portion extending from its respective final end towards its respective receiving opening, with at least a part of the final end of the tubular section of the second receiving portion. Preferably, said longitudinal portion of the tubular section of the first receiving portion corresponds to an upper portion/part of the tubular section with respect to the second direction (which is a vertical direction). Preferably, said longitudinal portion of the tubular section of the first receiving portion extends from its respective final end towards its respective receiving opening by at least a 40-60%, more preferably by at least an 80-100%, of the first length. The configuration of the first reinforcing element is also applicable for the second reinforcing element with regard to those embodiments in which the final end of the tubular section of the second receiving portion is a final end surface or a final end opening. Further, the first and second reinforcing elements may be connected to each other, wherein said connection is preferably arranged in an area placed between the tubular sections of the first and second receiving portions (e.g., arranged substantially coincident with the offset distance described below).

In some embodiments, the first reinforcing element may be configured such that its thickness in the second direction (z) progressively increases (i.e. increases in a linear or geometrical progression) from a part of the first reinforcing element arranged closest to the receiving opening of the second receiving portion towards a part of the first reinforcing element arranged closest to the final end of the second receiving portion. Complementarily or alternatively, the second reinforcing element may be configured such that its thickness in the second direction (z) progressively increases (i.e. increases in a linear or geometrical progression) from a part of the second reinforcing element arranged closest to the receiving opening of the first receiving portion towards a part of the second reinforcing element arranged closest to the final end of the first receiving portion. In some embodiments, the first reinforcing part may be configured to have a greater mass and volume than the second reinforcing part, thereby the first reinforcing part being configured to withstand higher stresses than the second reinforcing part. The increment of thickness may be configured as a lineal increment or as a non-lineal increment, wherein preferably a non-linear increment may be configured such that the thickness increments more dramatically the further it moves away from the respective receiving aperture.

In preferred embodiments, the inner walls of the first and second receiving portions may be separated along the first direction (x) by an offset distance. The offset distance is measured as the projection on the first direction (x) of a distance between a point of the inner wall of the first receiving portion being arranged closest to the inner wall of the second receiving portion and a point of the inner wall of the second receiving portion being arranged closest to the inner wall of the first receiving portion. Preferably, the offset distance has a length in the range of 50-200%, preferably 75-125%, and more preferably 90-110%, of the first distance. In some embodiments, the offset distance may have a negative value, i.e., the inner walls of the first and second receiving portions may be partially overlapping (i.e., one partially arranged over the other) along the first direction (x).

In some embodiments of the invention, the structural connecting device may further comprise one or more auxiliary connecting holes configured to connect at least one external auxiliary element/part to the structural connecting device. Preferably, at least one auxiliary connecting hole may be configured to be connectable to a rear-view mirror. The at least one auxiliary connecting hole for connecting a rear-mirror may be arranged in an upper part of the first or the second receiving portion. However, in preferred embodiments this hole may be arranged aligned with or parallel to the first central geometrical axis, such that said auxiliary connecting hole may be arranged in the final end of the tubular section of the first receiving portion and/or in the first reinforcing element.

In advantageous embodiments, one or more of the auxiliary connecting holes are specifically configured to connect a handguard structure. A handguard structure is an optional safety equipment that normally comprises a reinforcing bar (normally, a curved metal bar) for protecting both the hand and the lever (e.g., the clutch lever or the brake lever) in the event of the motorbike or bicycle falling down, and further normally comprises plastic cover and a plurality of auxiliary connecting elements. Said metal reinforcing bar (or handguard bar) is generally configured such that one of its ends is connected to an end of the handlebar and the other end of the metal reinforcing bar is connected to a zone of the handlebar arranged between a handgrip portion and an area for connecting/clamping the handlebar to the motorcycle/bicycle. Due to the limited space available in the handlebar, said zone normally coincides with a part of the handlebar that is bent upwards for ergonomic purposes, and which sometimes is further configured to have a variable diameter, thereby making it difficult to connect the handguard structure to the handlebar. In addition, the connection of the handguard structure to the previously described zone of the handlebar normally requires the incorporation of one or more additional auxiliary connecting elements for clamping the reinforcing bar to the handlebar, therefore increasing the complexity and difficulty of its installation. In order to overcome these disadvantages, in some embodiments of the invention, the structural connecting device may comprise one or more (preferably, two holes) auxiliary connecting holes specifically configured to directly connect a handguard reinforcing bar. Thus, the typical connection of the handguard structure to a problematic zone of the handlebar is replaced by a direct connection to the structural connecting device, thereby reducing the complexity of the installation, as well as reducing the number of parts to be connected. In preferred embodiments, the one or more (preferably, two) auxiliary connecting holes configured to connect a handguard structure may be arranged in an upper or front portion/part of the tubular section of the first or the second receiving portions (a front portion/part is identified as a part of the respective tubular section arranged in a frontal position of the motorcycle/bicycle, i.e. distally arranged with respect to the rider when using the vehicle, since the rider is behind the handlebar, thereby facing a rear portion/part of the tubular section).

A second aspect of the invention refers to a handlebar for a motorcycle/bicycle configured as a multi-part handlebar assembly. The multi-part handlebar assembly may comprise at least one and preferably two structural connecting devices according to the invention (e.g., a first and a second structural connecting devices). The second structural connecting device may be configured as a mirror copy of the first structural connecting device, i.e., the second structural connecting device may be a symmetrical copy of the first structural connecting device with respect a vertical plane centred with respect to an overall width of the vehicle. Thus, the two symmetrical structural connecting devices may form a first pair of structural connecting devices intended to be used in a multi-part handlebar configuration/assembly.

The multi-part handlebar assembly may further comprise a central bar configured to be connected to the motorcycle/bicycle (e.g. to the fork) by means of one or more clamping means, and a first and a second lateral bars. Each of the central bar and the two lateral bars comprises a respective first bar end and a respective second bar end. Each lateral bar may comprise a handgrip portion close to its respective second bar end. Preferably, all the bars are configured as straight bars or as bars comprising tapered bar ends.

The multi-part handlebar assembly may be configured such that the first bar end of the central bar is connected to the tubular section of the first receiving portion of the first structural connecting device, wherein said first bar end may be attached to the first receiving portion of the first structural connecting device by at least one (preferably by two) mechanical attaching element according to the description provided. Further, the second bar end of the central bar may be connected to the tubular section of the first receiving portion of the second structural connecting device, said second bar end being attached to the first receiving portion of the second structural connecting device by at least one mechanical attaching element. The first bar end of the first lateral bar may be connected to the tubular section of the second receiving portion of the first structural connecting device, wherein said first bar end may be attached to the second receiving portion of the first structural connecting device by at least one mechanical attaching element according to any of the embodiments previously described. The first bar end of the second lateral bar may be connected to the tubular section of the second receiving portion of the second structural connecting device, wherein said first bar end may be attached to the second receiving portion of the second structural connecting device by at least one mechanical attaching element according to any of the embodiments previously described.

In preferred embodiments, the central bar, the first lateral bar, the second lateral bar, and the tubular sections of the first and second receiving portions may be cylindrical (i.e. the tubular straight sections may be configured as tubular straight sections). The central bar may have a diameter in the range 22 to 35 mm, preferably 26 to 30 mm, more preferably 28.60 mm. The first and second lateral bars have a diameter in the range 14 to 29 mm, preferably 20 to 24 mm, more preferably 22 mm.

According to some embodiments, at least one (preferably all of them) of the central bar, the first lateral bar and/or the second lateral bar is made of metal, preferably made of aluminium, steel or titanium, and more preferably made of aluminium Al7075 T6. Thus, the bars may be configured as straight bars made of metal. The prior art solutions of a handlebar comprising a single tubular bar, conveniently curved for ergonomic purposes, are prevented from using such a rigid material, since it is difficult to bent, therefore having to use some less rigid materials, thereby not being able to provide an outstanding resistance, which leads to earlier breaking of the bar. The present invention solves this problem by providing straight bars of a rigid material (e.g., A17075 T6) conveniently connected by means of one or more structural connecting devices.

In some embodiments, the fitting tolerance of the first and second bar ends of the central bar with respect to the tubular section of the first receiving bodies of the first and second structural connecting devices may be in the range 0.01 to 0.03 mm, more preferably 0.02 mm. This fitting tolerance provides a rigidity that has been proven to be adequate for both on-road and off-road purposes, while at the same time provides a tight adjustment that allows an improved distribution of the efforts on the inner wall of the respective tubular section, thereby reducing the load supported by the one or more respective mechanical attaching elements.

According to some embodiments, the multi-part handlebar assembly may further comprise at least one damping element which has been previously described for the structural connecting device. It is noted that the damping element may regarded a part belonging to the structural connecting device or to the multi-part handlebar assembly indistinctly. Preferably, the at least one damping element is configured as a sleeve/bushing element (e.g., having a circular cross-section, such as a hollow cylinder having a surrounding wall with a thickness), configured to be inserted into the tubular section of the second receiving portion(s), such that the damping sleeve is arranged between the first bar end of the respective lateral bar and the inner wall of the respective tubular section of the respective second receiving portion.

The at least one damping element may be configured according to the description previously provided in relation to the structural connecting device. Thus, made of plastic material having elastic properties, preferably as a polymer, such as nylon or polyurethane (e.g. polyurethane resin) or polyethylene (PE) (especially a high-density polyethylene HDPE). In preferred embodiments, the damping element may me made of a PE in the range PE-200 to PE-600, preferably in the range PE-400 to PE-500 or may be made of polyurethane resin. The damping element may be configured to have a circular cross-section (e.g. as a hollow cylinder). The at least one damping element may have a surrounding wall with a thickness in the range 1 to 6 mm, preferably 2 to 5 mm, and more preferably 3 to 4 mm. The damping element is preferably configured to extend along at least a part of the length of the respective first end bar of the respective lateral bar, and/or along at least a part of the second length (i.e., the length of a tubular section of the second receiving portion).

The damping element may be configured to have a hardness measured in shores in the range 75 A to 98 A shores, preferably in the range 80 A to 96 A shores and more preferably in the range 90 A to 95 A shores. This ranges converges to a damping behaviour with an improved relation between absorption of energy (i.e. damping effect) and vehicle controllability.

IThe combination of a damping element as described with a fitting tolerance of the first and second bar ends of the central bar with respect to the tubular section of the first receiving bodies of the first and second structural connecting devices in the range 0.01 to 0.03 (preferably 0.02 mm) provides an even further improved comfort, since the handlebar provides enough information related to the surface over which the vehicle travels, while providing an energy absorption ratio that filters the hardest impacts, such that the rider does not receive the associated energy entirely.

In preferred embodiments, the central bar may have a length in the range in the range 250 mm to 300 mm (preferably 27 mm to 290 mm, and more preferably 284 mm), and the first and second lateral bars may have a length in the range 200 mm to 300 mm (preferably 250 mm). The first bar end of the first and second lateral bars and the first and second bar ends of the central bar may have a respective length in the range 30 to 70 mm, preferably in the range 40 to 60 mm, and more preferably in the range 45 to 50 mm.

According to some embodiments, and as previously described, the multi-part handlebar assembly may further comprise one or more auxiliary elements/parts connected to one or more respective auxiliary connecting holes arranged in the structural connecting device. In some embodiments at least one of the structural connecting devices may comprise auxiliary connecting holes connected to a rear-mirror and/or to a handguard structure, wherein the handguard structure may comprise a handguard bar (i.e., the element providing structural protection) and, optionally, a plastic cover (which is intended to provide wind deflection and protection against other elements, such as tree branches). In some embodiments, the one or more auxiliary elements/parts may comprise at least one handguard structure, and/or at least one rear-mirror, and/or at least one action camera, and/or at least one GPS navigator. It is noted that, although the first and the second structural connecting devices are symmetrical one to each other, this symmetry may be applicable or optional to the disposition of auxiliary connecting holes in both devices, inasmuch as some of the possible auxiliary elements may be arranged only in one of the devices (e.g. a rear-mirror may be arranged only in the left side of the handlebar, an action camera or a GPS navigator may be arranged only in one of the sides of the handlebar).

A third aspect of the invention refers to a kit for a multi-part handlebar assembly comprising a plurality of pairs of symmetrical structural connecting devices, wherein each pair of symmetrical structural devices may be configured to provide a different ergonomic adjustment/setting and/or to serve a specific use of the vehicle (motorcycle/bicycle). For example, the first pair of structural connecting devices may be configured according to any of the embodiments previously described, while the second pair of structural connecting devices may be configured to have at least one of the following parameters set to a different value/range: the third distance and/or the first angle and/or the second angle and/or the offset distance. In preferred embodiments, the first pair of structural connecting devices may be specifically configured to have a third distance in a first range (e.g., in the range of 50-160%, preferably 100-140%, of the first distance), wherein the second pair of structural connecting devices may be configured to have a third distance in a second range being higher than the first range (e.g., 161-250%, preferably 180-200%, of the first distance). In these embodiments, the first distance is a common feature between both pairs of structural connecting devices, and may be in the ranges previously disclosed, i.e.: 11 mm to 17.5 mm, preferably 13 mm to 15 mm, and more preferably measures specifically 14.3 mm.

### BRIEF DESCRIPTION OF THE FIGURES

The figures show possible ways of realising the embodiments of the invention. However, the embodiments depicted in the figures below have an aesthetic character, so that other alternative aesthetic configurations could be considered as long as they remain within the scope of protection of the claims.

FIG. 1 illustrates a first embodiment of a multi-part handlebar assembly according to embodiments of the invention.

FIGS. 2A-2D illustrate a first embodiment of a structural connection device according to the invention, and compatible with the multi-part handlebar assembly of FIG. 1. FIGS. 2A-2D depict several views of said structural connection device.

FIGS. 3A-3G illustrate a second embodiment of a structural connecting device compatible with the multi-part handlebar assembly of FIG. 1. In particular, FIGS. 3A-3G show a plurality of views of the structural connecting device.

FIG. 4A-4I illustrates a third embodiment of a structural connecting device according to the invention, and compatible with the multipart handlebar assembly of FIG. 1. FIGS. 4A-4I show different views of such a device.

FIG. 5A-5F illustrates several embodiments of the multi-part handlebar assembly according to the invention.

### DESCRIPTION OF PREFERRED EMBODIMENTS OF THE INVENTION

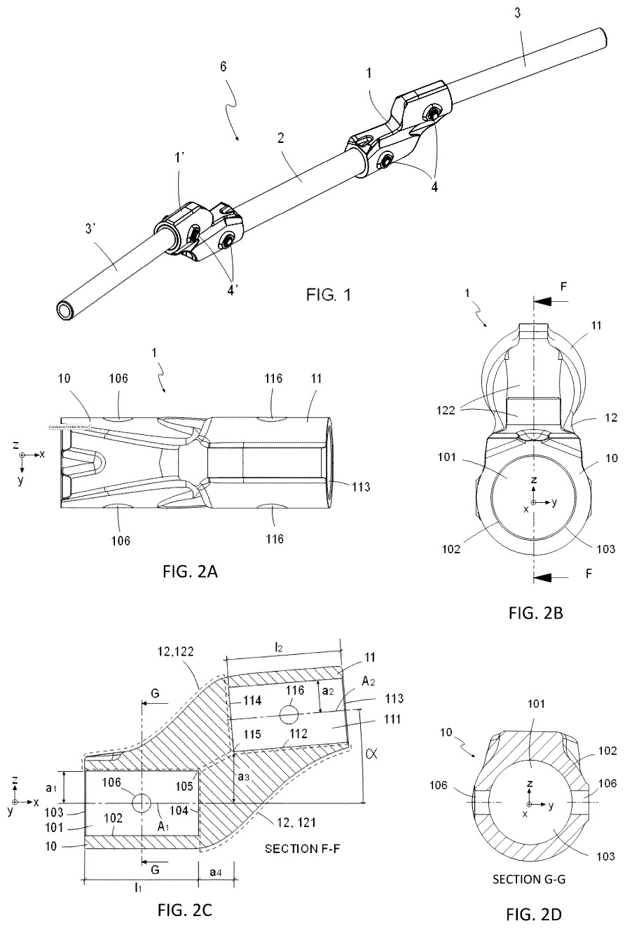

FIG. 1 shows a first embodiment of a multi-part handlebar assembly 6 according to the invention. The multi-part handlebar assembly 6 comprises two structural connecting devices (i.e., a first 1 and a second 1′ structural connecting devices) according to embodiments of the invention. The second structural 1′ connecting device is configured as a mirror copy of the first structural connecting device 1, i.e., the second structural connecting device 1′ may be a symmetrical copy of the first structural connecting device 1 with respect a vertical plane centred with respect to an overall width of the vehicle. Thus, the two symmetrical structural connecting devices 1 and 1′ may form a first pair of structural connecting devices. The configuration of the multi-part handlebar assembly 6 shown in FIG. 1 is compatible with any of the embodiments described for the structural connecting device(s).

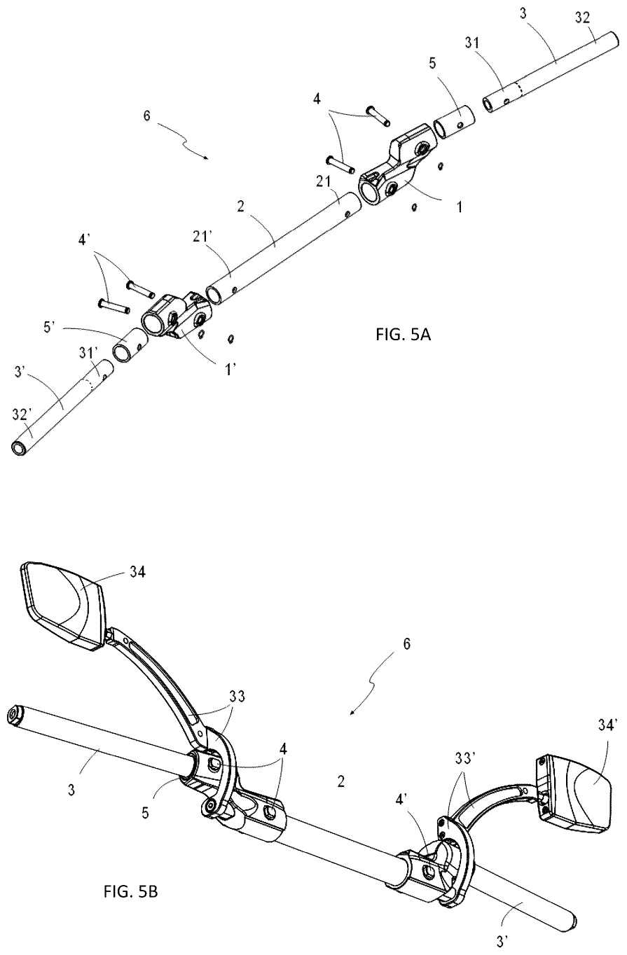

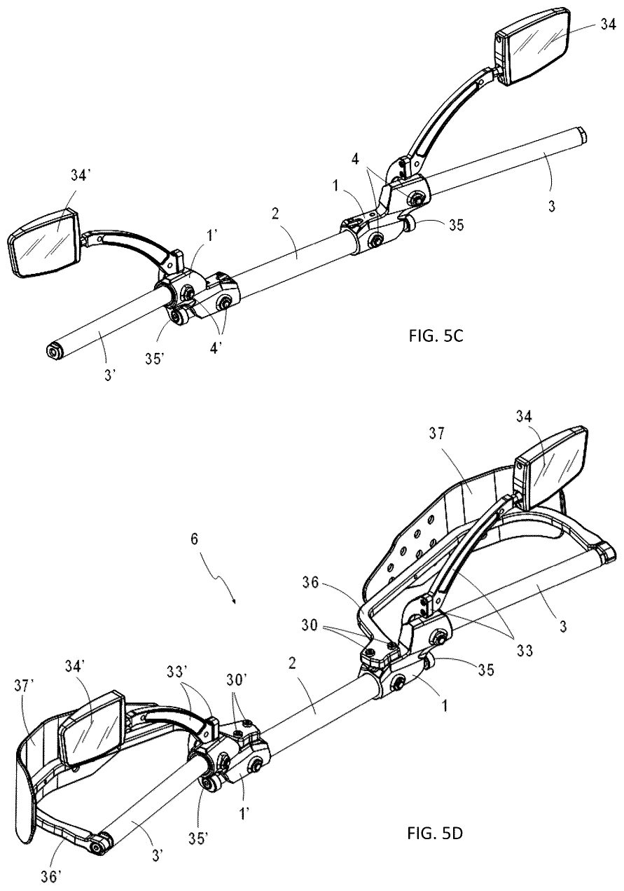

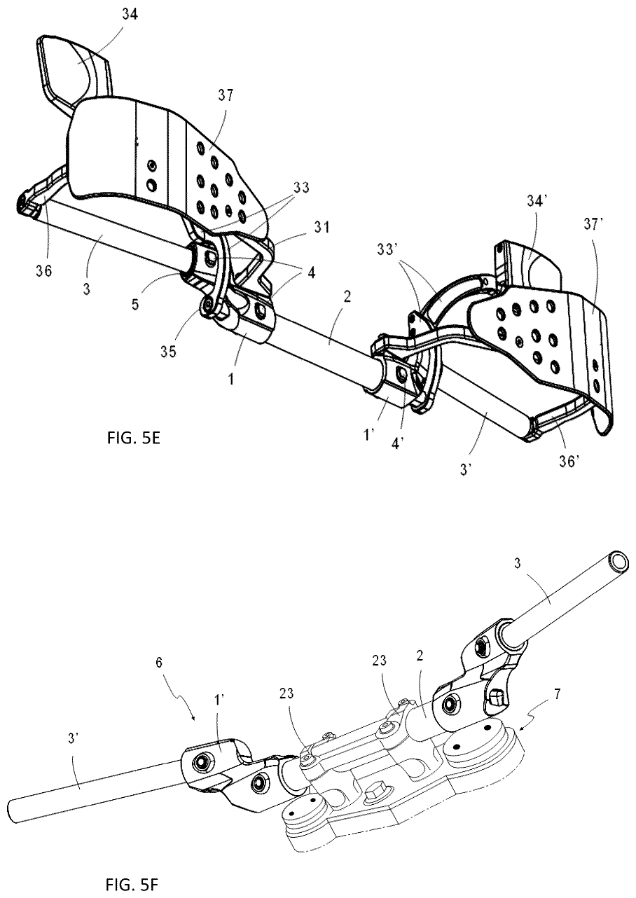

The multi-part handlebar assembly 6 of FIG. 1 comprises a central bar 2 configured to be connected to the motorcycle/bicycle by means of one or more clamping means 23 (shown in FIG. 5F), and a first 3 and a second 3′ lateral bars. Each of the central bar 2 and the two lateral bars 3 and 3′ are configured as tubular bars, wherein each of them comprises a respective first bar end and a respective second bar end. The lateral bars are intended to comprise respective gripping portions so that a user of a vehicle having a multi-part handlebar assembly as described is allowed to operate the handenbar through them.

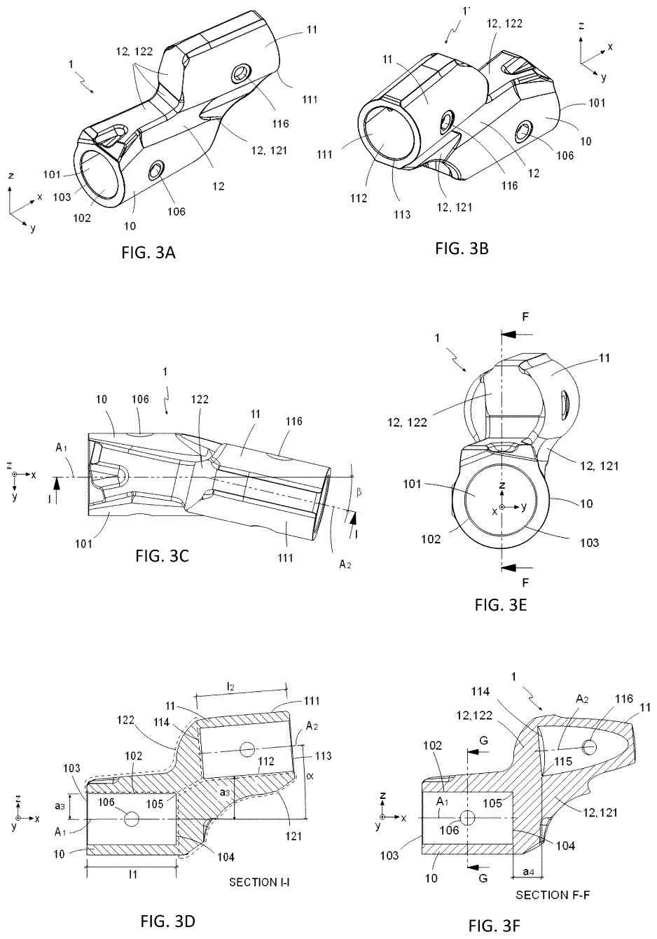

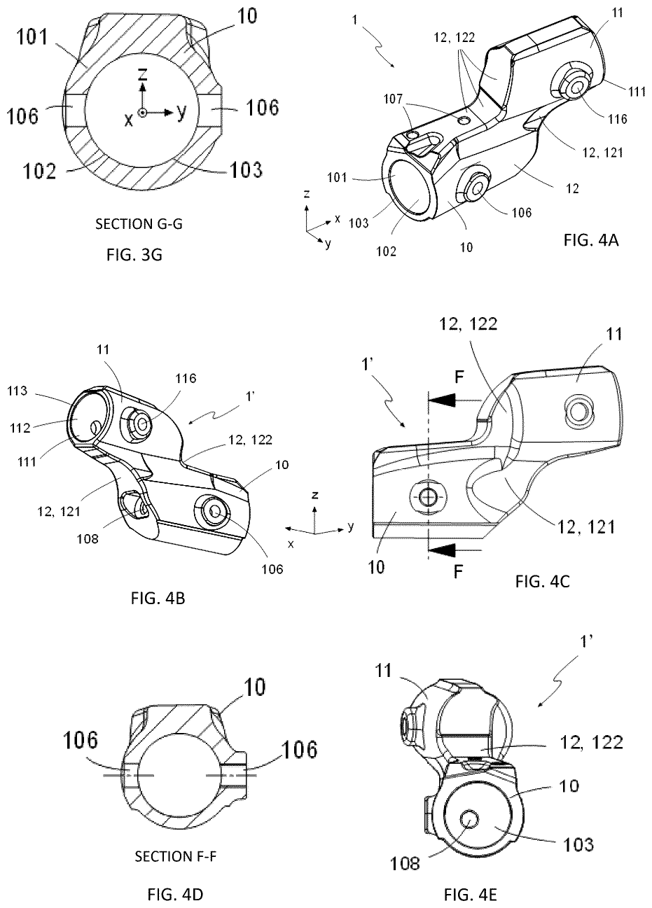

FIGS. 2A-2D depict different views of a structural connecting device 1 according to the invention. It is noted that the structural connecting device 1 shown in FIGS. 2A-2D corresponds to the device 1 to be installed on a right side of the multi-part handlebar structure 6. The structural connecting device 1′ for the left side is a symmetrical copy of the device 1′, wherein this symmetry does necessarily apply to the optional auxiliary connecting holes 107 and 108 (shown in the embodiment of FIGS. 3A-3G), since each structural connecting device may be equipped with different (or the same) external auxiliary element(s).

The structural connecting device 1 of FIGS. 2A-2D is a monobloc/monolithic part that comprises respective first 10 and second 11 receiving portions and an intermediate connecting portion 12 (including the portions 121 and 122 marked with a dotted line) configured to connect the first 10 and second 11 receiving portions. Each of the first 10 and second 11 receiving portions comprises a tubular section 101/111 comprising a respective tubular inner wall 102/112 extending longitudinally (i.e., along the longitudinal direction of the respective tubular section) from a receiving opening 103/113, through the respective receiving portion 10/11, up until a final end 104/114 of the respective tubular section 101/111. For each of the first 10 and second 11 receiving portions, the respective receiving opening 103/113 and the respective final 104/114 end are configured as the two respective longitudinal distal (and opposed) end portions of the respective receiving portion 10/11. The receiving opening 103 of the first receiving portions 10 is configured to receive a bar end 21/21′ of the central bar 2, while the receiving opening 113 of the second receiving portion 11 is configured to receive a bar end 31/31′ of one of the latera′ bars 3/3′.

The intermediate connecting portion 12 is configured to connect the first 10 and second 11 receiving portions, such that the receiving openings 103/113 of the first 10 and second 11 receiving portions are arranged as respective longitudinal ends (i.e. as opposed ends along a longitudinal direction of the structural connecting device) of the structural connecting device 1/1′, such that the two respective final ends (i.e. of the first and second receiving portions) are arranged between the receiving openings 103 and 113 in the longitudinal direction “x” of the structural connecting device 1. However, in some embodiments, only one of the respective final ends 104/114 may be arranged between the two receiving 103 and 113 openings in the longitudinal direction of the structural connecting device (e.g., the other final end may be aligned with the receiving opening of the other receiving portion).

The tubular section 101 of the first receiving portion 10 has a first length I₁ extending longitudinally along and around a first central geometrical axis A₁ extending along a first direction “x”, wherein the first central geometrical axis A₁ is separated from the respective inner wall 102 by a first distance a₁ in a radial direction of said axis A₁. Although not indicated in any of the FIGS. 2A-2D, the first distance a₁ may have a length in the range 11 mm to 17.5 mm, preferably 13 mm to 15 mm, and more preferably measures 14.3 mm. The first length I₁ shown in FIG. 2C measures 3.5 times the first distance a₁. However, in some embodiments compatible with the invention the first length I₁ may be configured to measure 2 to 5 times the first distance a₁, preferably 3 to 4 times.

The tubular section 111 of the second receiving portion 11 is configured to have a second length I₂ extending longitudinally along and around a second central geometrical axis A₂ extending partially along the first direction “x”, and to a lesser extent, also partially in a second direction “y”, the second direction “z” being perpendicular to the first direction “x”. Thereby, a first angle α is defined/formed between the first geometrical axis A₁ and a projection of the second central geometrical axis A₂ on a first geometrical plane formed by the first central geometrical axis A₁ and the second direction “z”. It is noted that in the embodiments shown in FIGS. 2A-2D the second geometrical axis A₂ is already contained in said first geometrical plane, so that the projection coincides with the current position of the second geometrical axis A₂ as shown in FIG. 2C. The first angle α may be interpreted as intended to provide an upward inclination of the lateral bars 3/3′ in a preferred position of use of the structural connecting device 1/1′. Further, the second central geometrical axis A₂ is separated from the respective inner wall 112 of the second receiving portion by a second distance a₂ in a radial direction of said axis.

The first angle α shown in FIG. 2C has a value of 4.66 degrees, which is a preferred value. However, in some compatible embodiments, the first angle α may be smaller than 45 degrees, and may be in the range 0.5 to 30 degrees, preferably 3 to 8 degrees, and more preferably 4 to 6 degrees. Although not indicated in any of the FIGS. 2A-2D, the second distance a₂ may have a length in the range 11 mm to 17.5 mm, preferably 13 mm to 15 mm, and more preferably measures 14.3 mm. The second length I₂ shown in FIG. 2C measures 3.5 times the second distance a₂. However, in some embodiments compatible with the invention the second length I₂ may be configured to measure 2 to 5 times the second distance a₂, preferably 3 to 4 times. In a preferred embodiment, the first length I₁ may be longer that the second length I₂ (e.g., the first length I₁ may measure 50 mm and the second length I₂ may measure 45 mm. Further, in some embodiments, the first distance a₁ and the second distance a₂ may be equals.

The tubular sections 10 and 11 shown in FIGS. 2A-2D have respective circular cross-sections, and are configured as tubular straight sections having a cylindrical configuration. However, other geometries are also compatible with the invention, as previously described. For example, one or both tubular sections 10 and 11 may be configured as tapered tubular sections (i.e. with the shape of a truncated cone). Alternatively, one or both tubular sections may be configured to have a cross-section in the form of a regular polygon, preferably having 4 to 16 sides. These configurations are compatible with any of the embodiments shown in the figures.

It should be noted that, when the tubular sections 10 and/or 11 are not configured as straight tubular sections, e.g. when they are configured as tapered tubular sections (i.e. having a variable distance with respect to its respective central geometrical axis (i.e. A₁ or A₂), then the first a₁ and second a₂ distances are interpreted as corresponding to the minimum (or the average) radial distances between the respective central geometrical axis (i.e. A₁ or A₂) and the respective inner wall (i.e. 102 or 112) (when considering the whole length of the respective tubular section).

The inner wall 112 of the second receiving portion 11 is positioned separated from the first central geometrical axis A₁ in the second direction “z”, such that a point 115 of the inner wall 112 of the second receiving portion 11 being arranged closest to the first central geometrical axis A₁ is spaced apart from said axis A₁ by a third distance as in the second direction “z”. Thus, the tubular section 111 of the second receiving portion 11 is arranged at a higher position in the second direction “z” (when the structural connecting device is arranged in a preferred position of use in which the second direction is a vertical direction) than the tubular section 101 of the first receiving portion 10. The third distance as shown in FIG. 2C measures approximately a 150% (i.e., 1.5 times) of the first distance a₁. However, in other compatible embodiments of the invention, the third distance a₃ may be in the range 50-250%, preferably 100-200%, and more preferably 140-160% of the first distance a₁.

In FIGS. 2A-2D the first receiving portion 10 is transversely crossed by a through-hole 106 (it should the embodiment is compatible with arranging one or more holes such that they do not cross the tubular section, but they are arranged tangentially to the tubular section) intended to receive the one or more mechanical attaching elements 4 configured to attach a respective bar end 21/21′ of the central bar 2 to the first receiving portion 10 of the device 1. In some alternative embodiments, the first receiving portion may be crossed by two through-holes 106 arranged next to each other and crossing the first geometrical axis A₁ perpendicularly. Additionally, in FIGS. 2A-2D the first second receiving portion 11 is transversely crossed by a through-hole 116 (it should be noted that said hole may be configured as one or more holes arranged such that they do not cross the tubular section, but they are arranged tangentially to the tubular section) intended to receive the one or more mechanical attaching elements 4 configured to attach a respective first bar end 31/31′ of one of the two lateral bars 3 to the second receiving portion 11 of the device 1 (this same hole 116 may also be used for fixing the optional damping element 5/5′).

FIG. 2C, which represents a lateral cutaway view of the device 1, and shows that the intermediate connecting portion 12 comprises an optional first reinforcing element 121 (e.g., a wall) configured to connect a longitudinal portion of the tubular section 111 of the second receiving portion 11 extending from its respective final end 114 until its respective receiving opening 113, with the final end 104 of the tubular section 10 of the first receiving portion 10. In some embodiments, the longitudinal portion may extend partially between the final end 114 towards the receiving aperture 113 (e.g., to extend by at least by a 40-60%, more preferably by at least 80-100%, of the second length), and also the connection may be stablished with at least a part of the final end 104 of the tubular section 101 of the first receiving portion 10. FIG. 2C depicts that the longitudinal portion of the tubular section 111 of the second receiving portion 11 corresponds to a lower portion/part (when considering the preferred position of use of the device 1/1′ shown in FIG. 1) of the tubular section 111 with respect to the second direction “z” (which corresponds to a vertical direction in the figures). The lower part refers to an area comprising a lower arc portion of the respective tubular section extending along the longitudinal direction of the tubular section.

FIG. 2C further depicts an optional second reinforcing element 122 (e.g., a wall). The intermediate connection portion 12 may comprise this second reinforcing element 122 regardless of whether the intermediate connecting portion comprises a first reinforcing 121 or not. The second reinforcing element/wall 122 shown in FIG. 2C is configured to connect a longitudinal portion of the tubular section 101 of the first receiving portion 10 extending from its respective final end 104 until its respective receiving opening 103, with the final end 114 of the tubular section 11 of the second receiving portion 11. In some embodiments, said longitudinal portion may extend partially between the final end 104 towards the receiving aperture 103 (e.g., to extend by at least by a 40-60%, more preferably by at least 80-100%, of the second length), and also the connection may be stablished with at least a part of the final end 114 of the tubular section 111 of the second receiving portion 11. The configuration of the first reinforcing element is also applicable for the second reinforcing element with regard to those embodiments in which the final end of the tubular section of the second receiving portion is a final end surface or a final end opening. Further, the first and second reinforcing elements may be connected to each other, wherein said connection is preferably arranged in an area placed between the tubular sections of the first and second receiving portions (e.g., arranged substantially coincident with the offset distance described below).

The final ends 104/114 of the tubular section 101/111 of the first 10 and of the second 11 receiving portion are configured in the embodiment of FIG. 2 as a final end surface (configured as a final end closing of the respective tubular section). It is noted, however, that in some embodiments compatible with the invention the final end 104 and/or the final end 114 may be configured as a final end opening, such that the respective tubular section passes through the intermediate connection portion 12.

The first reinforcing element of FIG. 2C is configured such that its thickness in the second direction “z” progressively increases from a part of the first reinforcing element 121 arranged closest to the receiving opening 113 of the second receiving portion 11 towards a part of the first reinforcing element 121 arranged closest to the final end 114 of the second receiving portion 11. Further, the second reinforcing element 122 is configured such that its thickness in the second direction “z” progressively increases from a part of the second reinforcing element 122 arranged closest to the receiving opening 103 of the first receiving portion 10 towards a part of the second reinforcing element 122 arranged closest to the final end 104 of the first receiving portion 10. The increment of thickness of the first 121 and the second 122 reinforcing elements is further configured as a non-lineal (although in some cases it may be linear) increment providing a progressively incremented thickness in the form of a curve, such that the respective thickness increments more dramatically the further it moves away from the respective receiving aperture 103/113.

FIG. 2C show that the inner walls 102/112 of the first 10 and second 11 receiving portions are separated along the first direction “x” by an offset distance a₄. The offset distance a₄ is measured as the projection on the first direction “x” of a distance between a point 105 of the inner wall 102 of the first receiving portion 10 being arranged closest to the inner wall 112 of the second receiving portion 11, and a point 115 of the inner wall 112 of the second receiving portion 11 being arranged closest to the inner wall 102 of the first receiving portion 10. Although it is not indicated in the figure, the offset distance a₄ may be in the range of 50-200%, preferably 75-125%, and more preferably 90-110%, of the first distance a₁. In some embodiments, the offset distance a₄ may have a negative value, such that the inner walls 102/112 of the first 10 and second 11 receiving portions may be partially overlapping (i.e., one partially arranged over the other) along the first direction “x”.

FIGS. 3A-3G depict a second embodiment of the structural connecting device 1/1′ based on the first embodiment shown in FIGS. 2A-2D , but comprising some additional features. In this case, FIG. 3A shows a structural connecting device 1 intended to be arranged on a right lateral side of a handlebar 6, while FIG. 3B shows a structural connecting device 1′ intended to be arranged on a left lateral side of a handlebar 6. FIGS. 3C-3G show different views specifically of the structural connecting device 1. In particular, the embodiment shown in FIGS. 3A-3F is compatible with all the features described for the embodiment of FIGS. 2A-2D, and is further configured such that the second central geometrical axis A₂ is further configured to extend partially along a third direction “y”, the third direction “y” being perpendicular to both the first “x” and second “z” directions, thereby defining a second angle β between the first central geometrical axis A₁ and a projection of the second geometrical central axis A₂ on a second geometrical plane formed by the first central geometrical axis A₁ and the third direction “y”. In FIG. 3C the second angle β measures specifically 13 degrees. However, in some embodiments, the second angle may be smaller than 45 degrees, or may be in the range 5 to 30 degrees, preferably 10 to 18 degrees, and more preferably 12 to 15 degrees (being 13 degrees a preferred value). The second angle β may be interpreted as intended to provide a backward inclination/tilt of the lateral bars 3/3′ (i.e., to provide an inclination towards the rider position when considering the preferred position of use of the structural connecting device 1/1′ in FIGS. 1, 5A-5F).

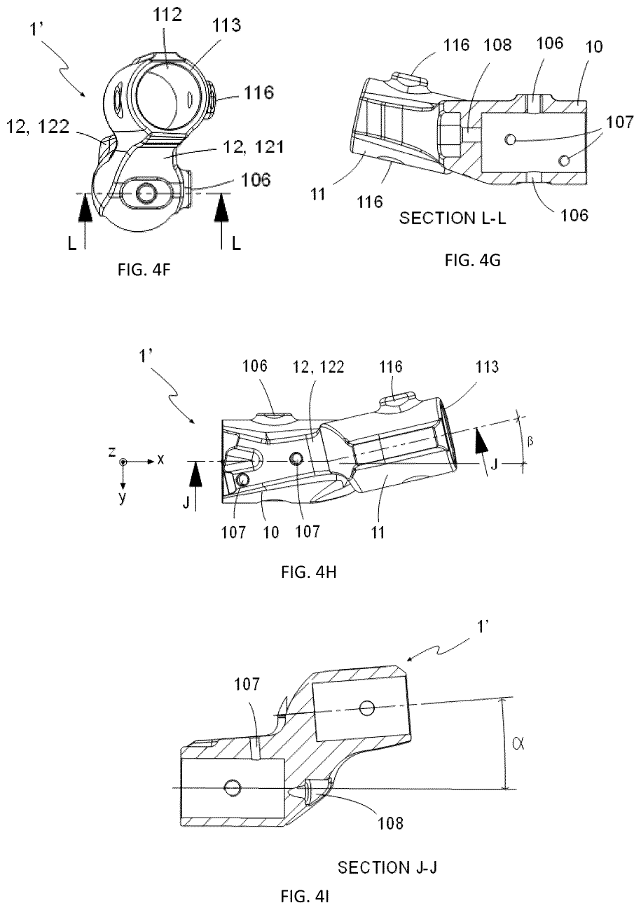

FIGS. 4A-4G show a third embodiment of the structural connecting device 1/1′ based on the second embodiment depicted in FIGS. 3A-3G, but comprising additional and optional features. FIG. 4A shows a structural connecting device 1 intended to be arranged on a right lateral side of a handlebar 6, while FIG. 4B shows a structural connecting device 1′ intended to be arranged on a left lateral side of a handlebar 6. FIGS. 4C-41 show different views specifically of the structural connecting device 1′. In particular, the embodiment shown in FIGS. 4A-41 is compatible with all the features described for the embodiments of FIGS. 2A-2D and FIGS. 3A-3G, and is further configured such that the structural connecting device 1/1′ further comprises a plurality of auxiliary connecting holes 107/108 configured to connect at least one external auxiliary element/part (e.g., at least one of an action camera, a GPS navigator or a handguard protective structure) to the structural connecting device 1/1′. However, in some embodiments a different position or number of auxiliary connecting holes 107/108 may be selected, e.g., one, two, three, four or more.

The embodiment of FIGS. 4A-4I comprises one optional auxiliary connecting hole 108 configured to be connectable to an external auxiliary element/part, such as a rear-view mirror (see FIGS. 5B-5E). The auxiliary connecting hole 108 is specifically arranged parallel to the first central geometrical axis A₁, such that said auxiliary connecting hole 18 is arranged passing through the first reinforcing element 121, but not passing through the final end 104 (which is configured as a final end surface) of the tubular section 101 of the first receiving portion 10 (although in some embodiments the auxiliary connecting hole 108 may also pass through the final end 104). However, it is noted that in some embodiments, the auxiliary connecting hole 18 for connecting a rear mirror may be arranged in a different position (e.g., in an upper part of the first 10 or the second 11 receiving portions) or may be compatible with other types of external auxiliary elements/parts (e.g., action camera, GPS navigator, handguard protective structure).

The embodiment of FIGS. 4A-4I further comprises two optional auxiliary connecting holes 107 configured to be connectable to a respective external auxiliary element/part (e.g., at least one of an action camera, a GPS navigator, or a handguard protective structure). In particular, the auxiliary connecting holes 107 are specifically configured to connect a handguard (protective) structure (see FIGS. 5B, 5D and 5E). The handguard structure comprises at least a handguard bar 36/36′ that comprises a first end connectable to the two auxiliary connecting holes 107, and a second end connectable to the second end 32/32′ of the respective lateral bar 3/3′. However, in some embodiments only one auxiliary connecting hole 107 may be required for connecting the handguard bar 36/36′. In FIGS. 4A-4I, the auxiliary connecting holes 107 configured to connect a handguard structure are specifically arranged on an upper portion/part of the tubular section 111 the second 11 receiving portion. In particular, said upper portion is configured as a substantially planar surface configured to provide a contact surface with the handguard bar of the handguard structure. In some alternative embodiments, the auxiliary connecting holes 107 configured to connect a handguard structure may be arranged in an upper or a front portion/part (optionally configured as a respective planar surface) of the tubular section 101/111 of the first 10 or the second 11 receiving portions (a front portion/part is identified as a part of the respective tubular section 10/11 arranged in a frontal position of the motorcycle/bicycle, i.e. distally arranged with respect to the rider when using the vehicle, since the rider is behind the handlebar 6, thereby facing a rear portion/part of the tubular section). The embodiment of FIGS. 4A-4I further comprises integrated threaded portions at the end of each of the through-holes 106/116, said threaded portions being preferably configured as integrated nuts. The threaded portions are intended to face the front of the vehicle. This feature is broadly compatible with any of the embodiments presented in the preceding figures. Also in a broadly compatible manner with the preceding embodiments, the integrated threaded portions may be replaced or combined with configuring the structural connecting device to receive by form-fitting one or more external nuts, such that the nuts are prevented from moving relative to the structural connecting device. Thus, the structural connection device may comprise one or more housing areas, each housing area having the shape of a nut to receive and form-fit with one of the nuts. Each integrated threaded portion and each (external) may be configured to be connected to a respective mechanical attaching element as previously described.

FIG. 5A depicts an exploded view of the multi-part handlebar assembly of FIG. 1, wherein said assembly 6 is configured such that the first bar end 21 of the central bar 2 is connected to the tubular section 101 of the first receiving portion 10 of the first structural connecting device 1, wherein said first bar end 21 is attached to the first receiving portion 10 of the first structural connecting device 1 by one mechanical attaching element 4 (e.g. a screw) according to the description provided. Optionally, two mechanical attaching elements 4 (e.g., two screws preferably arranged in different longitudinal positions of the first bar end 21) may be used instead of a single one. Further, the second bar end 21′ of the central bar 2 is connected to the tubular section 101 of the first receiving portion 10 of the second structural connecting device 1′, said second bar end 21′ is further attached to the first receiving portion 10 of the second structural connecting device 1′ by at least one, preferably two, mechanical attaching element 4, same as for the case of the first bar end 21. All the embodiments shown in FIGS. 2A-2D, 3A-3G and 4A-41 are compatible with the multi-part handlebar assembly 6 depicted in FIG. 5A.

The first bar end 31 of the first lateral bar 3 may be connected (e.g. by insertion) to the tubular section 111 of the second receiving portion 11 of the first structural connecting device 1, wherein said first bar end 31 is attached to the second receiving portion 11 of the first structural connecting device 1 by at least one mechanical attaching element 4 according to any of the embodiments previously described. The second lateral bar 3′ is connected to the second structural connecting device similarly. Thus, the first bar end 31′ of the second lateral bar 3′ is connected to the tubular section 111 of the second receiving portion 11 of the second structural connecting device 1′, wherein said first bar end 31′ is attached to the second receiving portion 11 of the second structural connecting device 1′ by at least one, preferably two, mechanical attaching element 4, according to any of the embodiments previously Although it is not visible in the figure, the structure connecting devices 1 and 1′ may be configured to provide a tight adjustment with respect to the first 21 and second 21′ bar ends of the central bar 2 (e.g., the fitting tolerance may be in the range 0.001 to 0.03 mm, more preferably 0.02 mm).

Further, FIG. 5A shows two damping elements 5 and 5′ (optional feature), each intended to be arranged between a first bar end 31/31′ of a respective lateral bar 3/3′ and the respective inner wall 112 of the tubular section 111 of the second portion 11 of the respective structural connecting devices 1 and 1′. It is noted that each of the damping elements 5 and 5′ is shown with the optional feature of being fixed in its position by means of the same at least one mechanical attaching element 4/4′ configured for attaching the respective first bar end 31/31′ to respective second receiving portion 11 of the respective structural connecting device 1/1′. The damping elements 5 and 5′ may be made of plastic material having elastic properties, preferably a polymer, such as nylon or polyurethane (e.g. polyurethane resin) or polyethylene (PE), especially a high-density polyethylene HDPE. In preferred embodiments, the damping element may me made of a PE in the range PE-200 to PE-600, preferably in the range PE-400 to PE-500 or may be made of polyurethane resin. The damping elements 5 and 5′ may be configured to have a circular cross-section (e.g. being configured as a hollow cylinder) having a surrounding wall with a thickness in the range 1 to 6 mm, preferably 2 to 5 mm, and more preferably 3 to 4 mm. The two damping elements 5 and 5′ shown in FIG. 5A have specifically a longitudinal length of 45 mm, a diameter of 28 mm and a wall thickness of 3 mm is depicted (although the measures are not visible).

The damping elements 5/5′ may be configured to have a hardness measured in shores in the range 75 A to 98 A shores, preferably in the range 80 A to 96 A shores and more preferably in the range 90 A to 95 A shores. This ranges converges to a damping behaviour with an improved relation between absorption of energy (i.e. damping effect) and vehicle controllability.

Further, the damping elements shown in FIG. 5A are configured to have a longitudinal length coinciding with the first length I₁, such that the damping element occupies the entire length of the corresponding tubular section 101. However, the damping elements 5 may be configured according to the specifications of any of the embodiments previously described (different measurements and/or materials).

In some compatible embodiments, further damping elements 5/5′ as previously described may be arranged within the tubular section 101 of the first 10 and second 11 receiving portions. In embodiments compatible with FIG. 5A, the first 3 and second 3′ lateral bars may have a length in the range 200 mm to 300 mm, preferably 250 mm. The first bar ends 31/31′ of the first 3 and second 3′ lateral bars and the first 21 and second 21′ bar ends of the central bar 2 may have a respective length in the range 30 to 70 mm, preferably in the range 40 to 60 mm, and more preferably in the range 45 to 50 mm. The central bar 2 may have a length in the range in the range 250 mm to 300 mm (preferably 27 mm to 290 mm, and more preferably 284 mm).

Although, the invention is compatible with other configurations, the embodiment of FIG. 5A shows that the diameter of the central bar 2 is greater than the diameter of the lateral bars 3 and 3′. Further, the damping elements 5 and 5′ may be configured to fill the gap (i.e. for each structural connecting device 1/1′) between the respective first end portions 31 and 31′ and the respective inner wall 112 of the second receiving portion 11.

FIGS. 5B and 5C depict respective front and rear views of a multi-part handlebar assembly 6 according to the invention further comprising two external auxiliary elements/parts configured as respective rear-mirrors (wherein each rear-mirror comprises a support 33/33′ and a mirror 34/34′), each connected to a respective auxiliary connecting hole 108 as described for the embodiment of FIGS. 4A-41 by means of a respective mechanical attaching means 35/35′.

FIGS. 5D-5E show respective front and rear views of the same multi-part handlebar assembly 6 of FIGS. 5B-5C, but further comprising a respective handguard structure connected to each structural connecting device 1/1′. Each handguard structure comprises a respective handguard bar 36/36′ that comprises a first end connectable to the two auxiliary connecting holes 107 shown in FIGS. 4A-41 by means of respective mechanical attaching means 30/30′, and a second end connectable to the second end 32/32′ of the respective lateral bar 3/3′. Further, each handguard structure comprises an optional plastic cover 37/37′. As previously described, in some embodiments only one auxiliary connecting hole 107 may be required for connecting the handguard bar 36/36′.

FIGS. 5B-5C describe a multi-part handlebar assembly 6 comprising rear-mirrors 34/34′ connected to the structural connecting devices 1 and 1′, while FIGS. 5D-5E show the same multi-part handlebar assembly 6, but further comprising handguard structures 31/31′. However, it is noted that in a preferred embodiment of the multi-part handlebar assembly 6, the structural connecting devices 1 and 1′ may be configured to be connectable to respective handguard structures and, optionally, may also be configured to be connectable to respective rear mirrors, such that a multi-part handlebar assembly 6 may comprise respective handguards structures 31/31′ and, optionally, rear-mirrors 34/34′

FIG. 5F shows a multi-part handlebar assembly according to embodiments of the invention, wherein the central bar 2 is attached to a motorcycle 7 by means of two clamping means 23.

1-20. (canceled)

21. A structural connecting device for a multi-part handlebar assembly of an off-road motorcycle/bicycle, the multi-part handlebar assembly comprising a central bar configured to be connected to the motorcycle/bicycle by one or more clamping means and two lateral bars, the structural connecting device configured for connecting a bar end of the central bar with a bar end of the lateral bar, wherein the structural connecting device is configured as a monobloc part comprising:
a first and a second receiving portions, each comprising:
a tubular section comprising a tubular inner wall extending longitudinally from a receiving opening, through the receiving portion, up until a final end of the tubular section;
wherein the tubular section of the first receiving portion is configured to receive a bar end of a central bar, and wherein the tubular section of the second receiving portion is configured to receive a bar end of a lateral bar; and
an intermediate connecting portion configured to connect the first and second receiving portions, such that the receiving openings of the first and second receiving portions are arranged as respective longitudinal ends of the structural connecting device, and such that at least one of the respective final ends is arranged between the two receiving openings;
wherein the tubular section of the first receiving portion is configured to have a first length extending longitudinally along a first central geometrical axis extending along a first direction, wherein the first central geometrical axis is separated from the respective inner wall by a first distance in a radial direction of said axis;
wherein the tubular section of the second receiving portion is configured to have a second length extending longitudinally along a second central geometrical axis extending partially along the first direction and, to a lesser extent, also partially in a second direction, the second direction being perpendicular to the first direction, thereby defining a first angle between the first geometrical axis and a projection of the second central geometrical axis on a first geometrical plane formed by the first central geometrical axis and the second direction, and wherein the second central geometrical axis is separated from the respective inner wall by a second distance in a radial direction of said axis; and
wherein the inner wall of the second receiving portion is positioned separated from the first central geometrical axis in the second direction, such that a point of the inner wall of the second receiving portion being arranged closest to the first central geometrical axis is spaced apart from said axis by a third distance in the second direction.

22. The structural connecting device of claim 21,
wherein the first angle is in a range of 0.5 to 30 degrees; and/or
wherein the second central geometrical axis is further configured to extend partially along a third direction, the third direction being perpendicular to both the first and second directions, thereby defining a second angle between the first central geometrical axis and a projection of the second axis on a second geometrical plane formed by the first central geometrical axis and the third direction; and wherein preferably the second angle is in a range of 5 to 30 degrees.

23. The structural connecting device of claim 22,
wherein the first length measures 2 to 5 times the first distance; the first distance being in a range of 11 mm to 17.5 mmm; and/or
wherein the second length measures 2 to 5 times the second distance, the second distance being in a range of 11 mm to 17.5 mm.

24. The structural connecting device of claim 23, wherein the tubular section of the first and/or of the second receiving portions is configured to receive at least one mechanical attaching element configured to fix/attach the respective bar end of a central bar or the respective bar end of a lateral bar to the respective tubular section.

25. The structural connecting device of claim 24, wherein the at least one mechanical attaching element is configured as at least one bolt/screw arranged transversely to the respective tubular section and/or as at least one bolt/screw arranged along the longitudinal direction of extension of the respective tubular section.

26. The structural connecting device of claim 25, wherein each mechanical attaching element configured as a bolt/screw is further configured to be connected to a respective nut;
wherein preferably the structural connecting device is configured to receive by form-fitting said respective nut, such that said respective nut is prevented from moving relative to the structural connecting device.

27. The structural connecting device of claim 21, further comprising a damping element arranged within the tubular section of the second receiving portion and configured as a spacer between said tubular section and a lateral bar).

28. The structural connecting device of claim 27, wherein:
the damping element is made of a plastic material; and/or
the damping element is configured to have a hardness measured in shores in a range of 75 A to 98 A shores.

29. The structural connecting device of claim 27, wherein the damping element has a thickness in a range of 1 to 6 mm.

30. The structural connecting device of claim 21, wherein the structural connecting device further comprises one or more auxiliary connecting holes configured to connect at least one external auxiliary part to the structural connecting device.

31. The structural connecting device of claim 21,
wherein the intermediate connecting portion comprises a first reinforcing element configured to connect at least a longitudinal portion of the tubular section of the second receiving portion extending from its respective final end towards its respective receiving opening, with at least a part of the final end of the tubular section of the first receiving portion; wherein said longitudinal portion of the tubular section of the second receiving portion extends from its respective final end towards its respective receiving opening by at least a 40-60% of the second length; and/or
wherein the intermediate connecting portion comprises a second reinforcing element configured to connect at least a longitudinal portion of the tubular section of the first receiving portion extending from its respective final end towards its respective receiving opening, with at least a part of the final end of the tubular section of the second receiving portion; wherein said longitudinal portion of the tubular section of the first receiving portion extends from its respective final end towards its respective receiving opening by at least a 40-60% of the first length.

32. The structural connecting device of claim 31,
wherein the first reinforcing element is configured such that its thickness in the second direction progressively increases from a part of the first reinforcing element arranged closest to the receiving opening of the second receiving portion towards a part of the first reinforcing element arranged closest to the final end of the second receiving portion; and/or
wherein the second reinforcing element is configured such that its thickness in the second direction progressively increases from a part of the second reinforcing element arranged closest to the receiving opening of the first receiving portion towards a part of the second reinforcing element arranged closest to the final end of the first receiving portion.

33. The structural connecting device of claim 21,
wherein the inner walls of the first and second receiving portions are separated along the first direction by an offset distance; and
wherein the offset distance is measured as the projection on the first direction of a distance between a point of the inner wall of the first receiving portion being arranged closest to the inner wall of the second receiving portion and a point of the inner wall of the second receiving portion being arranged closest to the inner wall of the first receiving portion;
wherein the offset distance has a length in a range of 50-200% of the first distance.

34. The structural connecting device of claim 21,
wherein the third distance in the second direction is in the range of 50-250% of the first distance; and/or
wherein the structural connecting device is made of a metal.

35. A multi-part handlebar assembly of an off-road motorcycle/bicycle, comprising:
a first and a second structural connecting devices according to claim 21;
a central bar configured to be connected to the motorcycle/bicycle by one or more clamping means, wherein the central bar comprises a first bar end and a second bar end;
a first and a second lateral bar, wherein each lateral bar respectively comprises a first bar end and a second bar end;
wherein the first bar end of the central bar is connected to the tubular section of the first receiving portion of the first structural connecting device, said first bar end being attached to the first receiving portion of the first structural connecting device by at least one mechanical attaching element;
wherein the second bar end of the central bar is connected to the tubular section of the first receiving portion of the second structural connecting device, said second bar end being attached to the first receiving portion of the second structural connecting device by at least one mechanical attaching element;
wherein the first bar end of the first lateral bar is connected to the tubular section of the second receiving portion of the first structural connecting device, said first bar end being attached to the second receiving portion of the first structural connecting device by at least one mechanical attaching element; and
wherein the first bar end of the second lateral bar is connected to the tubular section of the second receiving portion of the second structural connecting device, said first bar end being attached to the second receiving portion of the second structural connecting device by at least one mechanical attaching element.

36. The multi-part handlebar assembly of claim 35, further comprising at least two damping elements comprising a damping element arranged within the tubular section of the second receiving portion and configured as a spacer between said tubular section and a lateral bar, each damping element being configured to be inserted into the respective tubular section of the second receiving portion of one of the structural connecting devices, such that, for each structural connecting device, a respective damping element is arranged between the first bar end of the respective lateral bar and the respective tubular section of the respective second receiving portion; and
wherein the at least two damping elements are made of a plastic material, and/or have a thickness in a range of 1 to 6 mm.

37. The multi-part handlebar assembly of claim 36, further comprising at least one external auxiliary element connected to at least one of the structural connecting devices by one or more auxiliary connecting holes;
wherein the at least one auxiliary connecting element comprises two handguard structures, each connected to a respective structural connecting device, and/or one or two rear-mirrors, each connected to one of the structural connecting devices.

38. The multi-part handlebar assembly of claim 35,
wherein the central bar, the first lateral bar, the second lateral bar, and the tubular sections of the first and second receiving portions have circular cross-sections;
wherein the central bar has a diameter in the range 22 to 35 mm; and/or wherein the first and second lateral bars have a diameter in the range 14 to 29 mm.

39. The multi-part handlebar assembly of claim 35,
wherein a fitting tolerance of the first and second bar ends of the central bar with respect to the tubular section of the first receiving portion of the first and second structural connecting devices is in the range 0.01 to 0.03 mm; and/or
wherein at least one of the central bar, the first lateral bar, and the second lateral bar is made of metal.

40. The multi-part handlebar assembly of claim 35,
wherein the first and second lateral bars have a length in a range of 200 mm to 300 mm; and/or
wherein the first end bar of the first and second lateral bars has a respective length in the range 30 to 70 mm.
